(19) United States
(12) Patent Application Publication
(10) Pub. No.: US 2018/0242778 A1
(43) Pub. Date: Aug. 30, 2018

(54) KITCHENWARE WITH SEMI-OPENING TOP

(71) Applicant: George Papageorgiou, Velvedos Kozanus (GR)

(72) Inventor: George Papageorgiou, Velvedos Kozanus (GR)

(21) Appl. No.: 15/757,631

(22) PCT Filed: Sep. 14, 2016
(86) PCT No.: PCT/GR2016/000044

§ 371 Date: Mar. 5, 2018

(30) Foreign Application Priority Data
Sep. 22, 2015 (GR) 20150100411

(51) Int. Cl. A47J 36/12

(52) U.S. Cl. CPC A47J 36/12

(57) ABSTRACT

The kitchenware with semi-opening top is designed in such a way, so that its cover (6) opens without being removed from the main body (1) and apply in 2(a, b), or more positions for temporary release of vapor or foam during the cooking process, turning it to be more effective. This is achieved with the metal protrusions (7,8,9,10) on the utensil's cover (6) that apply on the bases of the main body (2,3,4,5) and the cover (6) remains closed or slightly open in the first scale (b) for less evaporation or more open in the second scale (a) for more evaporation.

The invention refers to a kitchenware that comprises of the main body and its cover equipped with metal protrusions.

Kitchenware with covers are familiar. Their covers are placed on these utensils, so that the kitchenware contents are cooked more quickly and effectively.

With the use of this kitchenware the contents often boil and the boiled water combined with the cooking material that contains starch and other nutrients causes spillover of the kitchenware's contents, despite the fact that the kitchenware is covered by its top.

The advantage of this invention is that its cover is adjusted in positions without removing it from the main body preventing the undesirable spillover; after this process, it can be replaced on the main body of the kitchenware.

The kitchenware with the semi-opening top, is designed so that its cover can be opened without being removed from the main body and placed in 2 or more positions to release temporarily vapor or foam that is created during the cooking process. This makes the cooking process more effective and after this release, the kitchenware top is placed on its former position on the main body, closed.

This is achieved with the metal protrusions on the kitchenware's cover that adjust on the metal bases of the utensil's main body and the top covers the main body or is adjusted slightly open at the first scale for partial release or more open at the second scale for more release.

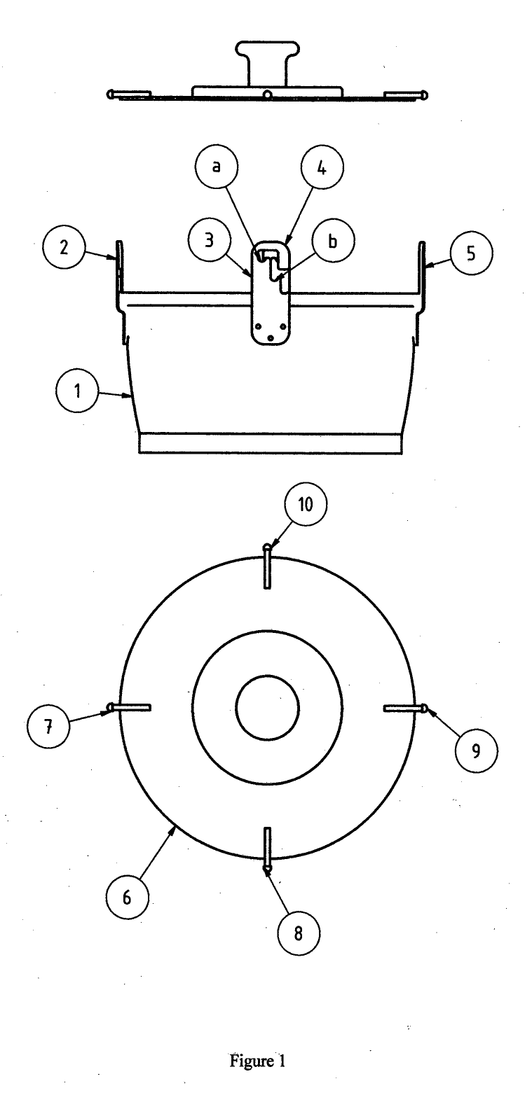

FIG. 1, depicts an aspect of the kitchenware with the semi-opening top open.

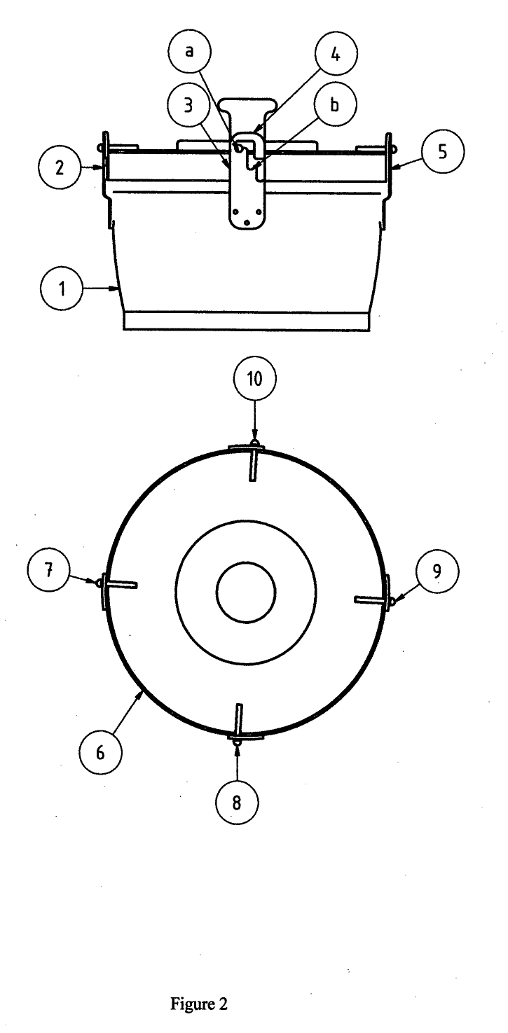

FIG. 2, depicts an aspect of the kitchenware with the semi-opening top in position (a), with the bigger distance of the cover from the main body.

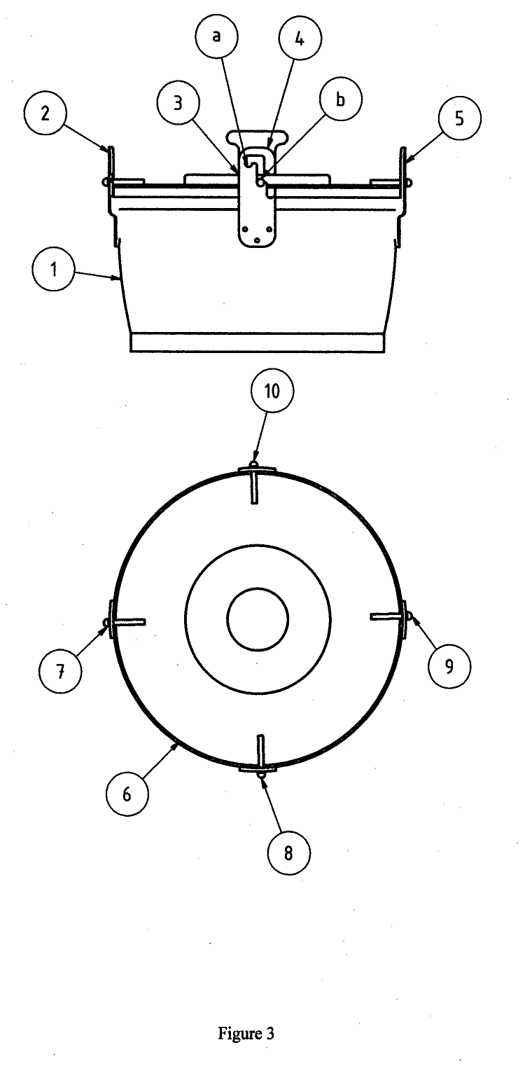

FIG. 3, depicts an aspect of the kitchenware with the semi-opening top in position (b), with the smaller distance of the cover from the main body.

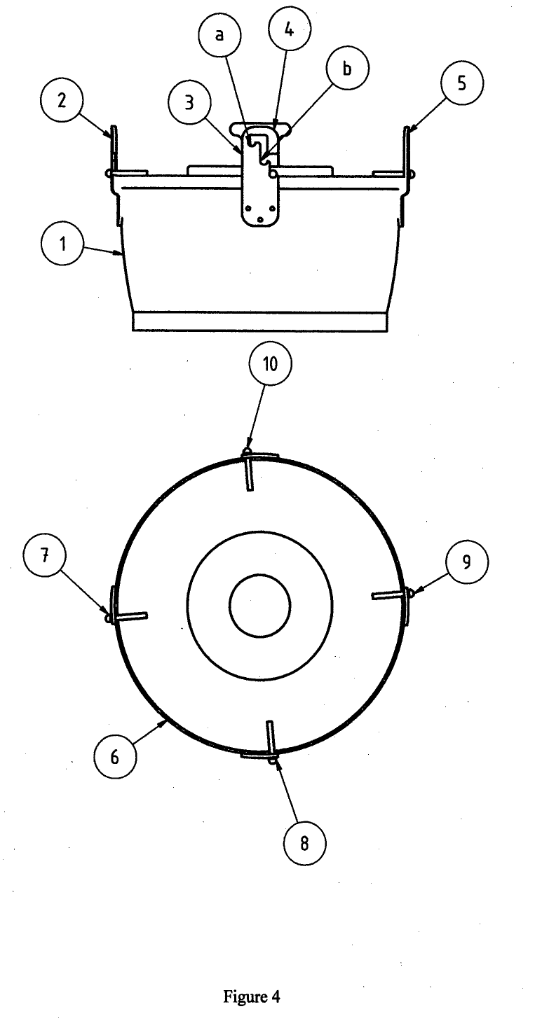

FIG. 4, depicts an aspect of the kitchenware with the semi-opening top placed on the main body.

One way to apply the invention can be described in relation to the figures.

The kitchenware with the semi-opening top, comprises from the main body (1) with its metal bases (2,3,4,5) and the cover (6) with the metal protrusions (7,8,9,10) that are adjusted on the metal bases, either in position (a) , or in position (b) according to the amount of vapor and foam needed to be released from the utensil during the cooking process. (if there is a large amount of vapor or foam to be released, the cover is adjusted in position (a) for more release, whereas if there is less vapor or foam, the cover is adjusted in position (b) for less release).

1. Kitchenware with semi-opening top, that comprises of 2 metal parts, the cover (6) with protrusions (7,8,9,10) and the main body (1) with bases (2,3,4,5) for the protrusions of the cover.

2. According to claim 1, the protrusions (7,8,9,10) and their bases (2,3,4,5) may be 3 or 4 depending to the specifications of efficiency in terms of the kitchenware's content (3 for less firm application of the cover to the main body, 4 for more firm).

3. According to claim 1, the protrusions of the cover (7,8,9,10) and the bases of the main body of the kitchenware (2,3,4,5) are comprised of metal in order to be durable to the high temperature during the cooking process.

4. According to claim 1, the protrusions of the cover (7,8,9,10) have rounded ends for safety, preventing use on sharp surface.

5. According to claim 1, the bases on the main body of the kitchenware (2,3,4,5) may be screwed on the main body, or adhered to it.

6. According to claim 1, the protrusions (7,8,9,10) are applied on the first position (a) of the main body, opening the cover for the kitchenware's contents release or in the second position (b) of the main body for more release of the contents of the utensil.

7. According to claim 1, the bases on the main body (2,3,4,5) may contain more than 2 cover application positions according to how much release of the utensil's contents is desired.
